(19) United States
(12) Patent Application Publication
(10) Pub. No.: US 2005/0004271 A1
(43) Pub. Date: Jan. 6, 2005

(54) Epoxy and nano-rubber powder complex material

(76) Inventor: Arthur Hong, Taichung Hsien (TW)

Correspondence Address: BACON & THOMAS, PLLC, 625 SLATERS LANE, FOURTH FLOOR, ALEXANDRIA, VA, 22314, US

(21) Appl. No.: 10/609,585

(22) Filed: Jul. 1, 2003

(51) Int. Cl. C08L 63/00; C08L 53/00

(52) U.S. Cl. 523/440; 525/88

(57) ABSTRACT

Present invention is an epoxy and nano-rubber powder complex material by mixing the rubber powder in nanometer size into the epoxy matrix and adding the enhance-fiber and hardener, then place the complex material of present invention into a die with high pressure and high temperature for indurating process. By the way, present invention can make a high performance epoxy complex material with high ductility and high thermostability and use to make sport products like bat, [symbol] fives bat, [symbol] hockey, [symbol] polo stick, [symbol] fishing pole, [symbol] golf club and whatnot. Wherein said complex material including 0.5˜20% of weight percentage of nano-rubber powder and 20˜60% of weight percentage of enhance-fiber and 5˜30 % of weight percentage of hardener or other additives.

### BACKGROUND OF THE INVENTION

1. Field of the Invention

The present invention relates to a complex material, and more particularly to an epoxy and nano-rubber powder complex material.

2. Description of the Related Art

An epoxy and enhance-fiber complex material has features of high intensity and thermostability and also has been used in sports and relaxation products like bat, [symbol] fives bat, [symbol] hockey, [symbol] polo stick, [symbol] fishing pole, [symbol] golf club and whatnot. But, there is a potential problem of the epoxy and enhance-fiber complex material, which is the impact resistance, is poor and makes those products cracky. The epoxy and enhance-fiber complex material uses liquid carboxyl rubber (CTBN) as a plasticizer as usually to increase the impact resistance of the epoxy and enhance-fiber complex material. The CTBN is one kind of the sticky liquid rubber and hard to work however. Also the quantity is too much as use the CTBN as an additive of the ductility-enhance agent whereat the thermostability of the epoxy and enhance-fiber complex material will be sacrificed and the applied area will be limited.

### SUMMARY OF THE INVENTION

Present invention is an epoxy and nano-rubber powder complex material for the problem of traditional CTBN and the character of present invention is mixing the rubber powder in nanometer dimension into the epoxy matrix and adding the enhance-fiber and the hardener, then place the complex material of present invention into a die in high pressure and high temperature for curing process. By the way, present invention can make a high performance epoxy complex material with high ductility and high thermostability and use to make sport products like bat, [symbol] fives bat, [symbol] hockey, [symbol] polo stick, [symbol] fishing pole, [symbol] golf club and whatnot.

### DETAILED DESCRIPTION OF THE INVENTION

The nano-rubber powder of present invention with the dimension of each particle is between 0.1˜1000 nanometer and 30˜200 is the better dimension there among. The dimension of the nano-rubber powder of these embodiments of present invention is between 10˜90 nanometer and the cast can include the styrene-butadiene rubber (SBR), [symbol] carboxyl styrene-butadiene rubber, [symbol] nitrile-butadiene rubber(NBR), [symbol] carboxyl nitrile-butadiene rubber, [symbol] butadiene rubber(NB), [symbol] acrylic rubber and so on. The making process of the nano-rubber powder is using the 10˜90 nanometer latex as a matrix. The matrix will turn into rubber cream after adding cross-linking agents and irradiating by r-Ray or electronic beam. The rubber cream will turn into nano-rubber powder after dehydrating and spray-drying it.

The impact resistance of the epoxy can be increased twice or more when mixing the nano-rubber powder of present invention into the epoxy matrix and the nano-rubber powder with functional group like carboxyl styrene-butadiene rubber or carboxyl nitrile-butadiene rubber can produce hydrogen bonding between the nano-rubber powder and the functional group of the epoxy. So the strength intensity between molecules of the epoxy can be increased and the Tg and the thermostability of the epoxy can be increased also.

The epoxy of present invention can be one kind of the Bisphenol A epoxy or the Bisphenol or the Novalac or multi-function epoxy.

The enhance-fiber of present invention can be glass fiber, [symbol] carbon fiber, [symbol] boron fiber, [symbol] aromatic polyester or polyamide with liquid-crystal phase.

The weight percentage of the nano-rubber powder of present invention in the whole complex material of epoxy/rubber powder/enhance-fiber is about 0.5˜20 percent and the enhance-fiber is about 20˜60 percent and 5˜30 percent of hardener or other additive therein still. The complex material that cured in the die in high pressure and high temperature can use to make many high performance plastic products like bat, [symbol] fives bat, [symbol] hockey, [symbol] polo stick, [symbol] fishing pole, [symbol] golf club and whatnot.

The hardener of present invention can be one kind of the normal hardener that uses in epoxy like the amineside, [symbol] oxalic acid-anhydroide and so on. The additive could be nano-argil, [symbol] titanic acid, [symbol] silica, [symbol] calcium carbonate or other flame retardant, [symbol] anti-static agent and facing.

According with the percentage shows in chart 1, mix the epoxy and nano-rubber powder and hardener and inject the complex material into a square die with 3 mm depth and curing for 30 minutes in 150° C. This test sample will be taken out of the die after it is cool and indurations and cut it into pieces as the ATSM asked to test the other mechanical intensity and thernostability.

The producing process of the enhance-fiber complex material of the ASTM standard test sample is mixing the epoxy and the nano-rubber powder and hardener with the carbon fiber by using the pre-preg work equipment and stacking the material and curing in high pressure and high temperature. Dieing the material into 3 mm in thickness as the ATSM asked to test the other mechanical intensity and thermostability.

Chart 1

The character of the epoxy/nano-rubber powder complex material

| | COMPA. | | |
|---|---|---|---|
| | EMBODI- | FIRST | SECOND |
| CONTENT | MENT | EMBODIMENT | EMBODIMENT |
| Epoxy | 100 | 100 | 100 |
| (Epon ®828) | | | |
| Carboxyl | — | 5 | 10 |
| nitrile-butadiene | | | |
| rubber | | | |
| DDS hardener | 15 | 15 | 15 |
| Tg(° C.) | 130° C. | 141° C. | 148° C. |
| Indentation | 1.2 | 3.4 | 4.9 |
| Impact | | | |
| Resistance | | | |
| (ASTM D-256) | | | |
| (kg · cm/cm) | | | |

The other embodiment of present invention is mixing the 3% of weight percentage of nano-rubber powder and 55% of weight percentage of enhance-fiber(carbon fiber) and 35% of weight percentage of epoxy(Bisphenol) and 5% of weight percentage of hardener (amineside) and 2% of weight percentage of additive (calcium carbonate) to become the complex material.

1. An epoxy and nano-rubber powder complex material cures in die in high pressure and high temperature comprising: 0.5˜20% of weight percentage of nano-rubber powder and 20˜60% of weight percentage of enhance-fiber and 5˜30% of weight percentage of hardener or other additive and the rest is epoxy.

2. The complex material as defined in claim 1, wherein said the content of the nano-rubber powder can be the styrene-butadiene rubber or the carboxyl styrene-butadiene rubber or the nitrile-butadiene rubber or the carboxyl nitrile-butadiene rubber or the butadiene rubber or the acrylic rubber.

3. The complex material as defined in claim 1, wherein said the enhance-fiber could be glass fiber, [symbol] carbon fiber, [symbol] boron fiber, [symbol] aromatic polyester or polyamide with liquid-crystal phase.

4. The complex material as defined in claim 1, wherein said the epoxy could be one kind of the Bisphenol A epoxy or the Bisphenol or the Novalac or multi-function epoxy.

5. The complex material as defined in claim 1, wherein said hardener could be one kind of the normal hardener that uses in epoxy like amineside, [symbol] oxalic acid-anhydroide and so on.

6. The complex material as defined in claim 1, wherein said additive could be nano-argil, [symbol] titanic acid, [symbol] silica, [symbol] calcium carbonate or other flame retardant, [symbol] anti-static agent and facing.

7. The complex material as defined in claim 1, wherein the dimension of each particle of said powder is between 0.1˜1000 nanometer and 30˜200 is the better dimension there among.

8. The complex material as defined in claim 1, wherein said material including 0.5˜20% of weight percentage of nano-rubber powder and 20˜60% of weight percentage of enhance-fiber.
